(19) United States
(12) Patent Application Publication
(10) Pub. No.: US 2008/0288444 A1
(43) Pub. Date: Nov. 20, 2008

(54) Evaluating Multi-Table Join Selectivity in a Computer Database

(76) Inventors: John Francis Edwards, Rochester, MN (US); Michael S. Faunce, Rochester, MN (US); Brian Robert Muras, Rochester, MN (US)

Correspondence Address: MARTIN & ASSOCIATES, LLC, P.O. BOX 548, CARTHAGE, MO, 64836-0548, US

(21) Appl. No.: 11/749,285

(22) Filed: May 16, 2007

(51) Int. Cl. G06F 17/30

(52) U.S. Cl. 707/2; 707/E17.017

(57) ABSTRACT

An improved method and apparatus is described for a query optimizer to evaluate multi-table join selectivities in a computer database. The query optimizer includes a statistics manager that finds the most appropriate set of assumptions and statistics to use when calculating the cost of an arbitrary join expression. As described herein, the statistics manager implements a unique bucket representation for the join expression. The bucket representation for the join expression can be evaluated and compared to the traditional domino expression so that the best possible estimate can be used. This new representation of the join expression allows the query optimizer to more accurately estimate the join selectivity for many queries compared to traditional representations.

### BACKGROUND

1. Technical Field

This invention generally relates to query optimization in a computer database system, and more specifically relates to evaluating multi-table join selectivity to improve the cost estimation of multi-table joins.

2. Background Art

A database is a computerized information storage and retrieval system that is structured to accept commands to store, retrieve and delete data using high-level query languages such as the Structured Query Language (SQL). SQL is a set of query commands for storing and retrieving data. A query contains one or more predicates which specify the information which the query should retrieve from the database.

Execution of a database query can be a resource-intensive process. In order to prevent an excessive drain on resources, many databases are configured with a query optimizer. The query optimizer analyzes an SQL query and determines more efficient ways to execute the query. A multi-table join query is a query that requests information from multiple tables that must be joined together to execute the query.

One way to make a multi-table join query more efficient is by optimizing the order in which the tables are joined. A good join order can reduce the number of comparisons made or the size of intermediate results, thereby decreasing the resources expended and the total cost necessary to perform the entire query. Obtaining a good join order requires a good estimate of the number of rows, the number of distinct values (herein known as the cardinality) and the percentage of returned rows compared to the number of total rows in the result set (herein known as the selectivity). The query optimizer utilizes a statistics manager that estimates the number of rows, the cardinalities and the selectivities of intermediate results to estimate the cost to execute a query that joins multiple tables. The statistics manager in the query optimizer arrives at the cost estimation of a particular query predicate based on the estimated join selectivity, where the estimated join selectivity is determined with statistical information available to the statistics manager.

A typical SQL statement is a SELECT-FROM-WHERE statement. The SELECT term indicates what columns to execute on. The SELECT term is followed by a FROM term that determines which tables to operate on, followed by a WHERE clause that identifies what values will be returned by the query. The WHERE clause in the SQL SELECT-FROM-WHERE statement must be converted into structures that allow the statistics manager to find a fit to competing assumptions and multiple sources of statistics in order to predict cardinalities and selectivities found in the actual data. The internal representation is important because it determines which assumptions and statistics can be applied to evaluate the selectivity of the multi-table join, so the selectivity can be used to estimate the cost of the query predicate.

While the prior art methods and structures to evaluate multi-table join selectivity work well when given some queries, they can be fairly inaccurate for many other queries. Without a more robust structure to represent queries to give a more efficient and accurate method for estimating optimal join ordering, computer databases will continue to suffer from reduced efficiencies of query execution.

### SUMMARY

An improved method and apparatus is described for a query optimizer to evaluate multi-table join selectivities in a computer database. The query optimizer includes a statistics manager that finds the most appropriate set of assumptions and statistics to use when calculating the cost of an arbitrary join expression. As described herein, the statistics manager implements a unique bucket representation for the join expression. The bucket representation for the join expression can be evaluated and compared to the traditional domino expression so that the best possible estimate can be used. This new representation of the join expression allows the query optimizer to more accurately estimate the join selectivity for many queries compared to traditional representations.

The disclosed examples are directed to a generic computer architecture and thus the disclosed methods could be implemented on any computer database system.

The foregoing and other features and advantages will be apparent from the following more particular description, as illustrated in the accompanying drawings.

### BRIEF DESCRIPTION OF DRAWINGS

The disclosure will be described in conjunction with the appended drawings, where like designations denote like elements, and:

FIG. 1 is a block diagram of a computer system with a query optimizer as described herein;

FIG. 2 is a method flow diagram for a query optimizer described herein; and

FIG. 3 is another method flow diagram for a query optimizer described herein.

### DETAILED DESCRIPTION

1.0 Overview

The disclosure and claims herein are directed to query optimizers that optimize database queries to a computer database. For those not familiar with databases, queries, or query optimizers, this overview section will provide background information that will help to understand these concepts.

Known Databases and Database Queries

There are many different types of databases known in the art. The most common is known as a relational database (RDB), which organizes data in tables that have rows that represent individual entries or records in the database, and columns that define what is stored in each entry or record.

To be useful, the data stored in databases must be able to be efficiently retrieved. The most common way to retrieve data from a database is to generate a database query. A database query is an expression that is evaluated by a database manager. The expression may contain one or more predicate expressions that are used to retrieve data from a database. For example, let's assume there is a database for a company that includes a table of employees, with columns in the table that represent the employee's name, address, phone number, gender, and salary. With data stored in this format, a query could be formulated that would retrieve the records for all female employees that have a salary greater than $40,000. Similarly, a query could be formulated that would retrieve the records for all employees that have a particular area code or telephone prefix. One popular way to define a query uses Structured Query Language (SQL). SQL defines a syntax for generating and processing queries that is independent of the actual structure and format of the database. When the database receives a query request, it produces an access plan to execute the query in the database. The plan may be stored in a plan cache for use with subsequent queries that use the same plan. In the prior art, a tool known as a query optimizer evaluates expressions in a query and optimizes the query and the access plan to access the database.

As introduced in the background, the query optimizer utilizes a statistics manager that estimates the number of rows, cardinalities and selectivities of intermediate results to estimate the cost to execute a query that joins multiple tables. The statistics manager in the query optimizer arrives at the cost estimation of a particular query predicate based on both the statistical information that is available to it as well as the internal representation of the query predicate. The WHERE predicate in the SQL SELECT-FROM-WHERE statement is converted into structures that allow the statistics manager to find a fit to make assumptions in order to predict the number of rows, cardinalities and selectivities of the query predicate applied to the actual data.

While prior art structures work well when given some queries, they do not provide a good structure for many other, different queries. Prior representations used to evaluate the selectivity of a join expression are somewhat inflexible and often lead to inaccurate results. An example will be illustrated for a join expression with four predicates using three tables. In this example, the join expression having four predicates represents a possible WHERE clause in an SELECT-FROM-WHERE statement where T1,T2, T3 are tables and C1,C2, C3 are columns therein.
T1.C1=T2.C1 and
T2.C1=T3.C1 and
T1.C2=T2.C2 and
T2.C2=T3.C2

In the prior art method to estimate the selectivity, we would first group these predicates into two expressions on the basis of which columns are joined to other columns. This method is similar to matching up the ends of a domino, so the method is referred to herein as the dominos method. In this example, the first two predicates would be added to a first network, and the second two predicates would be added to a second network as shown.
[T1.C1=T2.C1=T3.C1]
[T1.C2=T2.C2=T3.C2]

These two networks can then be combined or coalesced into a single network, where the colons represent columns that are concatenated together as follows.
[T1.C1:C2=T2.C1:C2=T3.C1:C2]

This is a “perfect” network for two reasons. First, when looking for the cardinality of the columns from each of the tables, there is the possibility of finding a statistic that gives us the cardinality of both columns together, such as an index or a column statistic over both columns. A statistic that gives the cardinality of multiple columns allows us to see correlations in the data. In addition, the minimum cardinalty can be found across the three tables which is used to provide a ceiling on the resulting join's cardinality. This value is critical in determining the selectivity of the expression, and the more tables we have in a single network, the more accurate is the estimate.

However, even a small deviation from the above form introduces several inaccuracies. For example, say we were to have the following join expression, where the fourth predicate is slightly different than it was above:
T1.C1=T2.C1 and
T2.C1=T3.C1 and
T1.C2=T2.C2 and
T2.C3=T3.C3

In this case, the “domino” mechanism groups the four predicates into three networks:
[T1.C1=T2.C1=T3.C1]
[T1.C2=T2.C2]
[T2.C3=T3.C3]

With this grouping, though we retain some of the broad view of the minimum cardinality, we lose the correlations between columns. In addition, the statistics manager must handle these three as independent join networks. As a result, an assumption of independence between the three networks is introduced. In order to calculate the overall selectivity of the full expression, the selectivity percentages from the individual networks are multiplied together. This is done in accordance with standard statistical practice of combining the probabilities of independent events. This multiplication is known as applying a ‘Probabilistic AND’ between the individual values. As such, introducing the assumption of independence often leads to a smaller estimated selectivity than is actually found in the data.

In the above example, a selectivity can be determined for the expression of the three networks determined by the prior art method. The selectivity is calculated for each of the three networks by using a common cardinality base formula. For example, the selectivity of each of the networks is approximately equal to the minimum cardinality of the predicates in the expression divided by the product of the cardinalities of all the predicates. The final estimated selectivity is found by multiplying the three individual estimates together. A formula representation of this calculation is shown below.

Min (Card(T1.C1), Card(T2.C1), Card(T3.C1))/product (Card(T1.C1), Card(T2.C1)), Card(T3.C1))*Min(Card(T1.C2), Card(T2.C2))/product (Card(T1.C2), Card(T2.C2))*Min(Card(T2.C3), Card(T3.C3))/product (Card(T2.C3), Card(T3.C3))

In summary, the prior art method and structure for evaluating multi-table join selectivity works well when given the “perfect” query, but is inaccurate with even slight changes in the query's structure. This disclosure introduces a method and a structure or representation for a statistics manager of a query optimizer to improve its selectivity calculations for join queries that don't meet the strict requirements of the “perfect” query.

2.0 Detailed Description

An improved method and apparatus is described for a query optimizer to evaluate multi-table join selectivities in a computer database. The query optimizer includes a statistics manager that uses multiple representations of a join expression in order to find which is the best fit to both the data in the underlying tables and to the available statistics over these tables. These statistics can take the form of single or multi-key indexes, single or multi-column statistics, or single or multi-column hash tables. In addition to the prior art domino representation, an optimizer uses a bucket representation of the query, then selects between the two in order to arrive at more accurate estimate. For any given join expression, the statistics manager can switch between which representation it uses to draw selectivity answers from depending on the part of the join expression being evaluated and depending on the sources of available statistics.

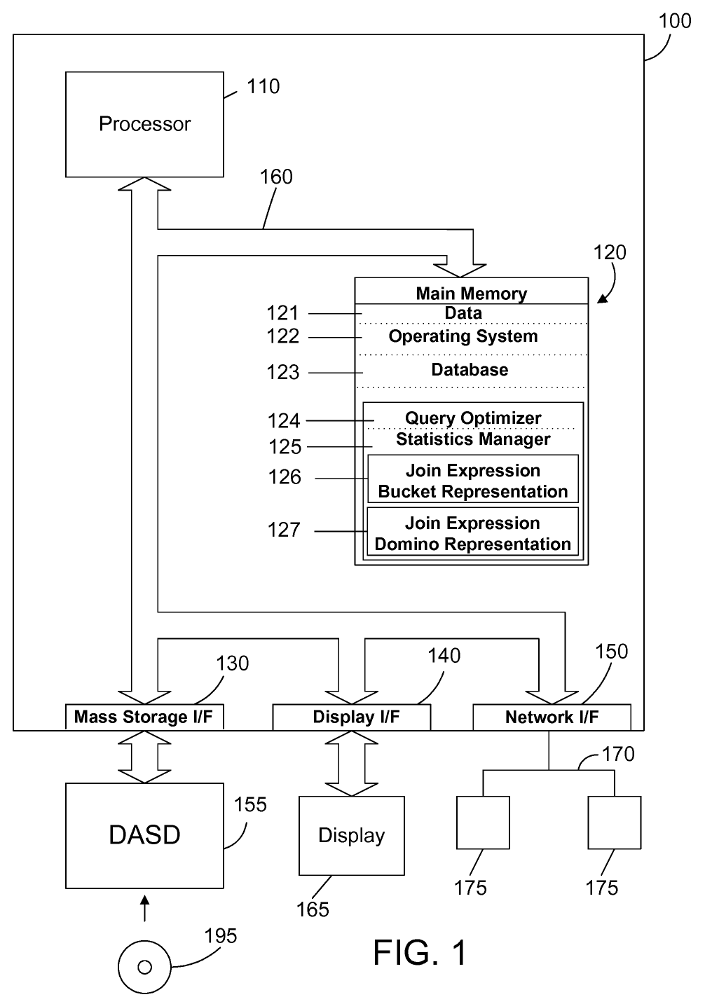

Referring to FIG. 1, a computer system 100 is one suitable implementation of the apparatus and method described herein. Computer system 100 is an IBM System i computer system. However, those skilled in the art will appreciate that the methods and apparatus described herein apply equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system managers are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 contains data 121, an operating system 122, a database 123, a query optimizer 124, a statistics manager 125, a join expression bucket representation 126, and a join expression domino representation 127. Data 121 represents any data that serves as input to or output from any program in computer system 100. Operating system 122 is a multitasking operating system known in the industry as i5/OS; however, those skilled in the art will appreciate that the spirit and scope of this disclosure and claims are not limited to any one operating system. Database 123 is any suitable database that includes tables, whether currently known or developed in the future. A query optimizer 124 is used to execute queries to the database 123. The main memory 120 includes a statistics manager 125 that accumulates and analyzes statistical information from previous queries to determine an optimal query execution. Note that query optimizer 124 and the statistics engine 125 are shown separate from database 123, but could also be implemented in database 123. Further, the statistics engine 125 may be integrated into the query optimizer 124. The statistics manager 125 puts a query expression into a join selectivity bucket representation 126 and a join selectivity domino representation 127 to analyze the join selectivity as described more fully below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, query optimizer 124, statistics manager 125, the join expression bucket representation 126, and the join expression domino representation 127 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that the improved query optimizer described herein may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that the improved query optimizer described herein applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The improved statistics manager in a query optimizer described herein applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the improved query optimizer has been and will continue to be described in the context of a fully functional computer system, those skilled in the art will appreciate that the query optimizer described herein is capable of being distributed as an article of manufacture in a variety of forms, and that the claims extend to all types of computer-readable media used to actually carry out the distribution. Examples of suitable computer-readable media include: recordable media such as floppy disks and CD-RW (e.g., 195 of FIG. 1).

The query optimizer evaluates multi-table join selectivities in a computer database to determine the most optimum join order of a query to optimize the query's use of system resources. The statistics manager includes a unique bucket representation for the join expression. The bucket representation for the join expression can be evaluated and compared to the traditional domino expression so that the best possible estimate can be used. This new representation of the join expression allows the query optimizer to more accurately estimate the join selectivity for many queries compared to traditional representations.

To illustrate this new representation, the same query introduced above with the domino method will again be analyzed. Thus, we begin with the following query predicates that represent a set of multi-table join predicates such as those of a WHERE clause:
T1.C1=T2.C1 and
T2.C1=T3.C1 and
T1.C2=T2.C2 and
T2.C3=T3.C3.

The new query representation introduces the separation of the query join predicates into one or more individual groups or buckets, where a bucket holds all predicates that have two tables in common. In this example, we find the following two buckets: one describing joins between T1 and T2, and the other describing joins between T2 and T3. So, for example, the predicate T1.C1=T2.C2 would fall into a bucket that contains columns from T1 and T2. Similarly, T2.C1=T3.C1 would fall into a bucket for T2 and T3. This gives the following intermediate representation of the query in two buckets.
Bucket 1: T1.C1=T2,C1
   T1.C2=T2.C2
Bucket 2: T2.C1=T3.C1
   T2.C3=T3.C3

From these two buckets, the statistics manager would build two join networks in a similar manner as previously know from the predicates in each bucket. Thus, where possible the statistics manager coalesces the predicates in each bucket into a single network. In this example, the predicates are coalesced as follows:
[T1.C1:C2=T2,C1:C2] (From the first bucket)
[T2.C1:C3=T3.C1:C3] (From the second bucket)

If the appropriate sources of statistics are available (for example, an index or column statistic over C1:C2), this pair of networks could lead to a more accurate selectivity than the three networks built from the domino technique. The two networks from the bucket technique would be able to utilize correlations between the pairs of columns that the domino technique would not be able to. Additionally, the bucket technique in this example would eliminate one of the Probabilistic ANDs that the domino technique introduced since there are only two terms that are ANDed together instead of three.

Another advantage of the bucket technique lies in an increased opportunity to find combinations of columns that define a unique key over the data from the table. When a statistics engine calculates a selectivity for a join, the occurrence of a unique key over the data helps improve the accuracy, as well as confidence, in the answers. The bucket technique also helps “distribute” uniqueness across the networks. For example, if both T1.C1 and T2.C2 are unique keys, then both networks are able to see that uniqueness, whereas that advantage would only be visible in one of the networks from the domino technique. Where these more accurate circumstances exist, then the confidence in the accuracy of the estimated selectivity is increased. When there is increased confidence in the accuracy of the estimated selectivity, then the statistics manager would choose the bucket representation to generate the selectivities of the join to determine the most optimum join order for the query execution. Alternatively, if the two representations produce similar confidence level of the accuracy of the estimated selectivity, the resulting estimated selectivity from the two representations can be combined together to form a combined result. The combined result could be an average, mean or some other combination of the results from the two representations.

In general, the join expression domino representation 127 (FIG. 1) emphasizes finding the minimum cardinality across a long string of common join predicates. However, by adding a bucket view of the join (join expression bucket representation 126), the statistics manager 125 can also ferret out correlations between columns that the domino mechanism would miss. Where a statistics manager builds both representations, it can then evaluate and choose between them the one most likely to accurately represent the data and give the most accurate selectivity for a given query. Thus the bucket approach gives the statistics manager greater flexibility for finding the best possible estimate of a query selectivity to produce the highest quality estimate. The criteria that a statistics engine may consider to evaluate the networks from the different representations to determine which is best may include finding the representation with the fewest Probabilistics ANDs (or Probabilistic ORs), the maximum number of unique keys distributed across the network, the most coorelated statistics sources, fewest default statistics sources (i.e., no source of statistic for a column(s)), furthest transitive closure chain, or any other criteria. If a best representation is not clearly indicated, a combination of the representations can be used.

In some cases, neither representation is clearly better than the other. For example, say a WHERE clause held these join predicates:
T1.C1=T2.C1 and
T1.C2=T2.C2 and
T2.C1=T3.C1

In this case, both representations would yield two networks. The Domino representation would return the following configuration:
[T1.C1=T2.C1=T3.C1]
[T1.C2=T2.C2]

And the bucket representation would return this configuration:
[T1.C1:C2=T2:C1:C2]
[T2.C1=T3.C1]

The statistics manager cannot choose between these two representations solely on the basis of number of resulting networks. In this case, the statistics manager could be constructed in a such a way that it can look at both the available sources of statistics and the underlying data and make a choice of which representation could yield the more accurate estimates of numbers of rows, cardinalities and selectivities.

For example, if there were three indexes with keys over only the first columns from the three tables, then the bucket representation would not be able to accurately discern correlations between the first two columns in the first two tables. However, the domino representation would be able to more accurately find the minimum cardinality across the string of three tables in the first of its networks. As such, the statistics manager would likely choose the domino representation because of the available statistics. Alternatively, there may be a sufficient configuration of statistics where the statistics manager could evaluate both representations with some high degree of accuracy. In this case, the statistics manager may decide to do its calculations using both representations, and then interpolate between the two results.

Another characteristic of the bucket mechanism is that it arrives at the same selectivity answer to the “perfect query” scenario as does the domino mechanism. The domino processing first uncovers two networks based on long strings of common columns:
[T1.C1=T2.C1=T3.C1]
[T1.C2=T2.C2=T3.C2]

A second step discovers that these “parallel” networks, and, as such, can be coalesced into a single network:
[T1.C1:C2=T2.C1:C2=T3.C1:C2]

Likewise, the bucket processing would also find two networks: The first bucket would contain join predicates over tables T1 and T2; the second bucket would contain join predicates over tables T2 and T3:
Bucket 1: T1.C1=T2,C1
   T1.C2=T2.C2
Bucket 2: T2.C1=T3.C1
   T2.C2=T3.C2

These two buckets would yield two networks
[T1.C1:C2=T2.C1:C2]
[T2.C1:C2=T3.C1:C3]

The final step would be to recognize that these two networks can be “linked” together though the common expression: T2:C1:C2. After linking the two networks, the bucket processing arrives at the same expression as did the domino processing:
[T1.C1:C2=T2.C1:C2=T3.C1:C2]

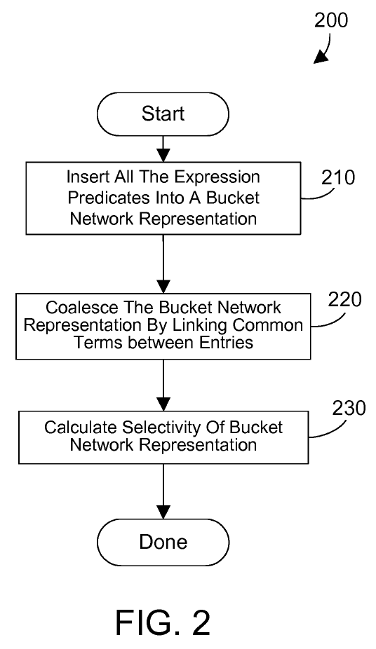

FIG. 2 illustrates a method 200 for a query optimizer to estimate a join selectivity to optimize a query. This method operates on a computer system 100 described above with reference to FIG. 1. The method 200 begins inserting all the expression predicates of the query expression to be analyzed into a bucket network representation (step 210). The predicates are placed such that each bucket holds all the predicates that have two tables in common. Then coalesce the bucket network representation by linking common terms between the entries (step 220). Then calculate the estimated selectivity of the expression (step 230) using the coalesced networks. The method is then done.

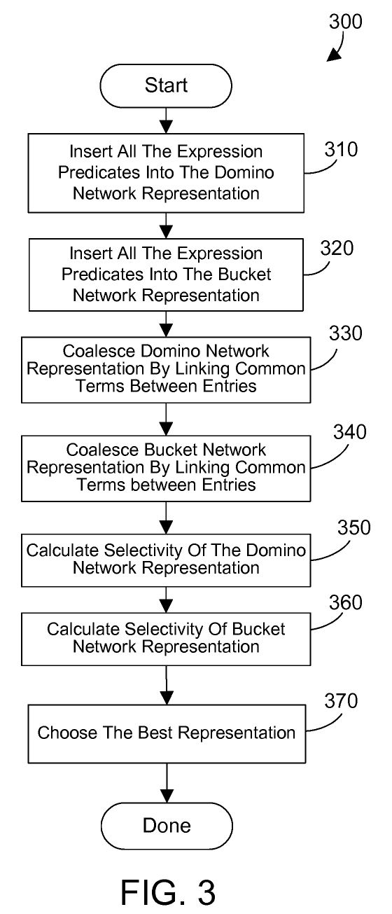

FIG. 3 illustrates a method 300 for a query optimizer to evaluate the best estimate of a join selectivity to optimize a query. This method operates on a computer system 100 described above with reference to FIG. 1. The method 300 begins by inserting all the expression predicates of the query expression to be analyzed into a domino network representation (step 310). Next, insert all the expression predicates of the query expression to be analyzed into a bucket network representation as described above (step 320). Then coalesce the domino network by linking common terms between the network entries (step 330). Then coalesce the bucket network list by linking common terms between the representation entries (step 340). Evaluate the selectivity of the domino network representation of the expression (step 350) and evaluate the selectivity of the bucket network representation (step 360). Both representations are evaluated as discussed above. Then compare the two coverages and select the best representation of the expression to estimate the query selectivity (step 370) as described above. The method is then done.

The disclosure herein describes an improved method for a query optimizer to evaluate multi-table join selectivities in a computer database. The query optimizer includes a statistics manager that uses a unique representation for the join expression that allows the query optimizer to more accurately estimate the join selectivity by reducing the number of probabilistic ANDs in the representation of the query and using correlations between multiple columns of data. The more accurate estimate of the join selectivity allows the query optimizer to determine a more efficient way to execute the query to improve overall efficiency of the computer system.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

What is claimed is:

1. A computer apparatus comprising:
at least one processor;
a memory coupled to the at least one processor;
a database residing in the memory;
a query that specifies a multi-table join with an expression having a plurality of predicates; and
a query optimizer that estimates a join selectivity of the query using a bucket representation of the expression that groups the plurality of predicates of the multi-table join into a plurality of buckets where each bucket contains all the join predicates with two tables in common, and wherein the query optimizer optimizes the query based on the estimated join selectivity.

2. The computer apparatus of claim 1 wherein the query optimizer combines the predicates in each bucket into an single join network.

3. The computer apparatus of claim 1 wherein the query optimizer optimizes the query by determining an optimal join order for the multiple-table join by estimating the join selectivity of the query.

4. The computer apparatus of claim 1 wherein the query optimizer determines whether to use the bucket representation or an other representation of the query by evaluating the bucket representation and the other representation to determine which would most likely produce the highest quality estimate.

5. The computer apparatus of claim 4 wherein the criteria for evaluating the bucket representation is one or more criteria chosen from the following: the representation with the fewest Probabilistics ANDs, the fewest Probabilistic ORs, the maximum number of unique keys distributed across the network, the most correlated statistics sources, fewest default statistics sources or the furthest transitive closure chain.

6. The computer apparatus of claim 5 wherein the query optimizer combines the predicates in each bucket into an single join network and optimizes the query by determining an optimal join order for the multiple-table join by calculating the join selectivity of the query.

7. The computer apparatus of claim 1 wherein the query optimizer uses a combination of results from the bucket representation and a domino representation of the query when the bucket representation and the domino representations produce a similar confidence level for the estimated join selectivity.

8. A computer implemented method for optimizing queries to data in a computer database comprising the steps of:
receiving a query that specifies a multi-table join with an expression having a plurality of predicates;
inserting the plurality of predicates into a plurality of buckets where each bucket contains all the join predicates with two tables in common; and
coalescing the predicates in each bucket by linking common terms.

9. The computer implemented method of claim 8 wherein the query optimizer optimizes the query by determining an optimal join order for the multiple-table join by calculating the join selectivity of the query.

10. The computer implemented method of claim 8 further comprising the step of determining whether to use the bucket representation or an other representation of the query by evaluating the bucket representation and the other representation to determine which would most likely produce the highest quality estimate.

11. The computer implemented method of claim 8 further comprising the step of determining whether to use the bucket representation or a domino representation of the query by evaluating the bucket representation and the domino representation to determine which would most likely produce the highest quality answer.

12. The computer implemented method of claim 11 wherein the step of determining whether to use the bucket representation or the domino representation of the query includes the steps of:
inserting the plurality of predicates into a domino representation;
coalescing the predicates in the domino representation;
evaluating the domino representation and the bucket representation; and
choosing the best representation.

13. The computer implemented method of claim 12 wherein the criteria for evaluating the bucket representation and the domino representation is one or more criteria chosen from the following: the representation with the fewest Probabilistics ANDs, the fewest Probabilistic ORs, the maximum number of unique keys distributed across the network, the most correlated statistics sources, fewest default statistics sources or the furthest transitive closure chain.

14. An article of manufacture comprising:
a query optimizer that estimates a join selectivity, wherein the query optimizer uses a bucket representation of an expression that groups a plurality of predicates of a multi-table join into a plurality of buckets where each bucket contains all the join predicates with two tables in common; and
a computer recordable media bearing computer instructions that implement the query optimizer when executed on a computer.

15. The article of manufacture of claim 14 wherein the query optimizer combines the predicates in each bucket into an single join network.

16. The article of manufacture of claim 14 wherein the query optimizer optimizes the query by determining an optimal join order for the multiple-table join by calculating the join selectivity of the query.

17. The article of manufacture of claim 14 wherein the query optimizer determines whether to use the bucket representation or a domino representation of the query by evaluating the bucket representation and the other representation to determine which would most likely produce the highest quality estimate.

18. The article of manufacture of claim 17 wherein the criteria for evaluating the bucket representation and the domino representation is one or more criteria chosen from the following: the representation with the fewest Probabilistics ANDs, the fewest Probabilistic ORs, the maximum number of unique keys distributed across the network, the most correlated statistics sources, fewest default statistics sources or the furthest transitive closure chain.

19. The article of manufacture of claim 18 wherein the query optimizer combines the predicates in each bucket into an single join network and optimizes the query by determining an optimal join order for the multiple-table join by calculating the join selectivity of the query.

20. The article of manufacture of claim 18 wherein the query optimizer uses a combination of results from the bucket representation and a domino representation of the query when the bucket representation and the domino representations produce a similar confidence level for the estimated join selectivity.
